(19) United States
(12) Patent Application Publication
(10) Pub. No.: US 2015/0071762 A1
(43) Pub. Date: Mar. 12, 2015

(54) EXHAUST GAS TURBOCHARGER WITH TURBINE

(71) Applicant: Bosch Mahle Turbo Systems GmbH, Stuttgart (DE)

(72) Inventor: Florian Rentz, Stuttgart (DE)

(21) Appl. No.: 14/484,234

(22) Filed: Sep. 11, 2014

(30) Foreign Application Priority Data
Sep. 12, 2013 (DE) 102013218303.8

(51) Int. Cl. F02B 37/22; F04D 29/056

(52) U.S. Cl. CPC F02B 37/22; F04D 29/056
USPC 415/111

(57) ABSTRACT

A turbine for a supercharging device of an internal combustion engine may include a control device for performance control of the turbine. The control device may include at least one actuator, which is pivotably mounted about a pivot axis relative to a turbine housing. The actuator may have a bearing shaft, which is mounted in a bearing of the turbine housing. The bearing shaft may include at least one bearing sleeve, which is radially in contact with the bearing.

### CROSS-REFERENCE TO RELATED APPLICATION

This application claims priority to German Patent Application No. 10 2013 218 303.8 filed Sep. 12, 2013, the contents of which are hereby incorporated by reference in their entirety.

### TECHNICAL FIELD

The present invention relates to a turbine for a supercharging device, in particular for an exhaust gas turbocharger, of an internal combustion engine. The invention additionally relates to an exhaust gas turbocharger that is equipped with such a turbine.

### BACKGROUND

Exhaust gas turbochargers for the performance increase of internal combustion engines are generally known. Such a turbocharger comprises a compressor for compressing fresh air to be fed to the combustion spaces of the internal combustion engine. The compressor is driven with the help of a turbine which in turn is driven by the exhaust gas of the internal combustion engine. A modern turbocharger can be equipped with a control device for the performance control of the turbine, for example in order to be able to adapt the performance of the turbine and thus the performance of the compressor to a current operating state of the internal combustion engine.

Such a control device can, in particular in the case of a diesel engine, be configured as a geometry adjusting device for generating a variable turbine geometry. With the help of such a geometry adjusting device a through-flow-capable cross section of an inlet channel leading to the turbine wheel can be changed on the inflow side of a turbine wheel of the turbine. For example, adjustable guide blades arranged in the inlet channel are used for this purpose. Accordingly, the guide blades are pivotably mounted on a blade carrier and additionally drive-connected to a common adjusting ring, which is practically arranged on a side of the blade carrier facing away from the inlet channel. By twisting the adjusting ring, all guide blades can be synchronously pivoted. For driving the adjusting ring, a drive lever is provided, which is pivotably mounted on a bearing. In this bearing, the drive lever with a bearing shaft penetrates the turbine housing. The drive lever is drive-connected to the adjusting ring inside in the turbine housing while it is drive-connected to an actuating drive of the geometry adjusting device outside on the turbine housing. To ensure high functional safety, the drive lever has to be mounted in the respective bearing with the least possible friction and least possible wear. To this end, the respective bearing can be equipped with a bearing bush. Provided that the bearing shaft is directly in contact with the bearing bush radially, the bearing shaft has to be matched with respect to its material to the material of the bush, as a result of which the bearing shaft and thus the drive lever are comparatively expensive.

Such a control device for the performance control of the turbine can, in particular in the case of a spark ignition engine, be a controllable bypass, i.e. a so-called waste gate. A waste gate usually comprises a bypass opening bypassing the turbine wheel, which is controllable with the help of a valve member. The valve member for this purpose is connected to a spindle in a rotationally fixed manner, which is rotatably mounted in a bearing on the turbine housing. Accordingly, the spindle penetrates the turbine housing with a bearing shaft. Inside in the turbine housing, the spindle is connected to the valve member while it is drive-connected to an actuating drive of the waste gate outside on the housing. Provided that the bearing contains a bearing bush, the bearing shaft has to be tribologically matched to the bush in order to be able to ensure a high functional safety for the waste gate with low wear and low friction. Thus, the bearing shaft and according also the spindle are also comparatively expensive here.

In principle, other control devices for the performance control of the turbine are also conceivable, in the case of which an actuator is mounted on the turbine housing in a bearing, wherein a bearing shaft of the actuator can penetrate the turbine housing.

### SUMMARY

The present invention deals with the problem of stating an improved embodiment for a turbine with control device, which is characterized in particular by a cost-effective producability.

According to the invention, this problem is solved through the subject of the independent claim. Advantageous embodiments are subject of the dependent claims.

The invention is based on the general idea of equipping the bearing shaft of the respective actuator of the control device with at least one bearing sleeve, which for mounting the bearing shaft is radially in contact with the bearing. Through the proposal according to the invention, mounting the bearing shaft in the respective bearing no longer takes place directly but indirectly via the respective bearing sleeve, so that the bearing shaft itself no longer comes into contact with the bearing in the region of the respective bearing sleeve. Because of this it is possible to realise the tribological matching between actuator and bearing with the help of the respective bearing sleeve while the bearing shaft and thus the actuator can otherwise be produced with comparatively cost-effective materials. Thus, the tribological system is reduced to the bearing and the respective bearing sleeve. As a consequence, low friction values and low wear values can be realised in the respective bearing with reduced production costs.

According to an advantageous embodiment, the bearing shaft can be radially in contact with the bearing exclusively via the at least one bearing sleeve. Thus, direct contact between bearing shaft and bearing can be avoided so that the bearing shaft as a whole can be produced from a comparatively cost-effective material.

The respective bearing sleeve can axially extend over the entire bearing shaft and/or over the entire bearing, so that only a single bearing sleeve is then used for each bearing shaft. Preferred, however, is an embodiment, in which at least two separate bearing sleeves are employed, which are arranged on the bearing shaft axially spaced from one another. For example, two such bearing sleeves are arranged on the two axial end regions of the bearing, since the greatest transverse forces occur in these end regions of the bearing. By using smaller, i.e. axially shorter bearing sleeves, the costs can be additionally reduced.

In another embodiment, the respective bearing sleeve can consist of another, preferentially higher-quality material than the bearing shaft. Because of this, wear and friction can be significantly reduced.

In another embodiment, the respective bearing shaft can comprise a bearing bush, which is in contact with the turbine housing radially outside and is in contact with the respective bearing sleeve radially inside. Because of this it is possible to produce the bearing bush from a material other than the turbine housing. In particular, the respective bearing sleeve can be tribologically matched to the bearing bush in order to realise a particularly low-friction and low-wear mounting. Practically, the bearing bush is arranged on the turbine housing in a rotationally fixed manner, so that the rotational mounting exclusively takes place inside in the bearing bush.

In an alternative embodiment, the respective bearing can be formed through a bearing opening which is formed in the turbine housing so that the respective bearing sleeve is in contact with the turbine housing. Such a design can be advantageous when the turbine housing in the region of the bearing is produced from a comparatively high-quality material anyway. Preferred, however, is the previously mentioned embodiment in which a bearing bush is employed in the respective bearing.

Practically, the respective bearing sleeve is arranged on the bearing shaft in a rotationally fixed manner so that the rotational mounting exclusively takes place outside on the bearing sleeve. Such a rotationally fixed arrangement can be realised in different ways. For example, a positively joined connection between bearing sleeve and bearing shaft can be realised. For example, the bearing shaft for this purpose can have an outer contour deviating from the circular cross section, while the bearing sleeve has an inner cross section that is complementary thereto. Furthermore, a frictionally joined connection is conceivable, wherein the respective bearing sleeve can be in particular pressed and/or shrunk onto the bearing shaft. Furthermore, a materially joined connection between the respective bearing sleeve and the bearing shaft is also conceivable, for example by means of a welding method or a soldering method.

According to another embodiment it can also be provided to produce the respective bearing sleeve directly on the bearing shaft, for example by means of a sintering process or by means of a metal-spraying method. Such methods however are comparatively complicated. Accordingly, the more cost-effective bearing sleeves realised as separate components are preferred.

According to an advantageous embodiment, the control device can be a geometry adjusting device for creating a variable turbine geometry, wherein the actuator is a drive lever for driving an adjusting ring for adjusting guide blades of the geometry adjusting device mounted on a blade carrier. Such a drive lever penetrates the turbine housing with its bearing shaft. The bearing shaft is drive connected to the adjusting ring inside in the turbine housing and drive connected to an adjusting drive of the geometry adjusting device outside on the turbine housing.

In an alternative embodiment, the control device can be a waste gate, wherein the actuator is a spindle for driving a valve member of the waste gate. Here, too, the spindle with its bearing shaft penetrates the bearing housing. Inside in the turbine housing, the bearing shaft is connected to the valve member while it is drive connected to an actuating drive of the waste gate outside on the turbine housing.

According to an advantageous embodiment, the respective bearing sleeve can be produced from a nickel-based alloy. Nickel-based alloys are characterized by particularly low wear and by particularly low friction.

The bearing sleeve can be nitrided, i.e. provided with a nitrided layer radially outside. This nitrided layer can for example have a radially measured thickness which can be in a range from including 5 μm to including 350 μm.

The respective bearing sleeve can be produced through forming For example, the respective bearing sleeve can be rolled out of a sheet metal strip. It is likewise possible to produce the respective bearing sleeve through deep-drawing or impact extrusion from a flat blank.

An exhaust gas turbocharger according to the invention comprises a compressor for compressing fresh air and a turbine of the type described above for expanding exhaust gas. Accordingly, the turbine is drive-connected to the compressor. In detail, a turbine wheel is accordingly drive-connected to a compressor wheel, for example via a common drive shaft.

Further important features and advantages of the invention are obtained from the subclaims, from the drawings and from the associated figure description with the help of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference characters relate to same or similar or functionally same components.

### BRIEF DESCRIPTION OF THE DRAWINGS

It shows, in each case schematically,

FIG. 1 an isometric view of a turbocharger in the region of a waste gate,

FIG. 2 a sectional view of the turbocharger in the region of a spindle of the waste gate,

FIG. 3 an isometric sectional view of the turbocharger in the region of a geometry adjusting device,

FIG. 4 an enlarged sectional view in the region of a drive lever.

### DETAILED DESCRIPTION

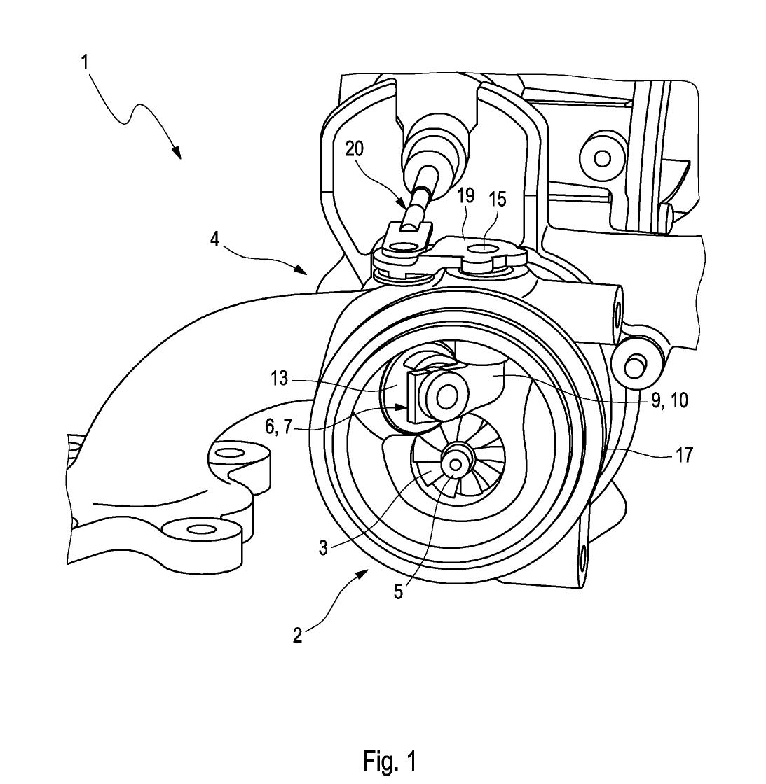

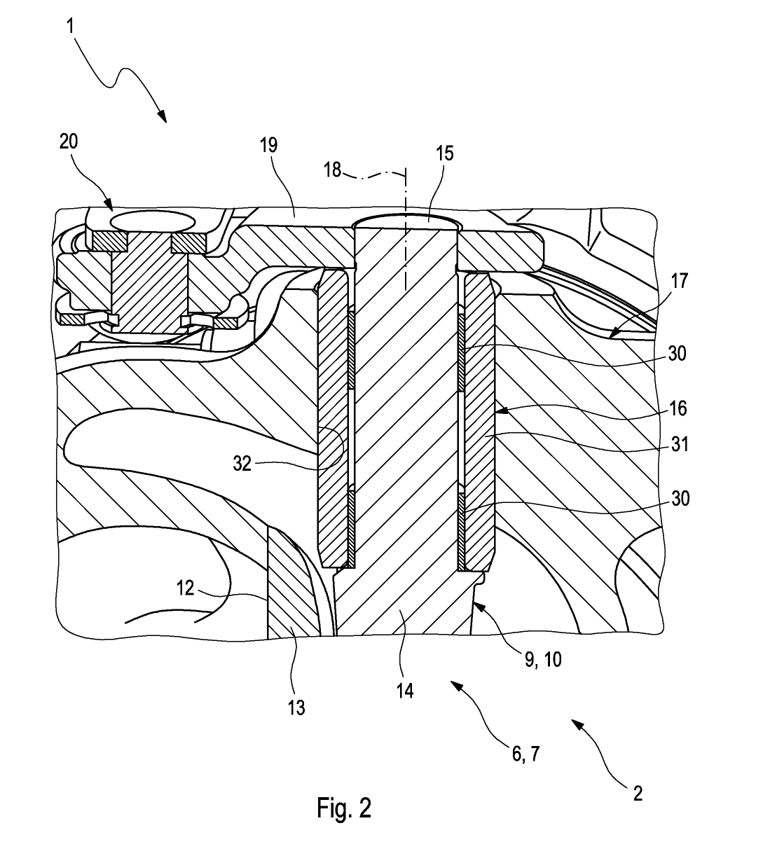

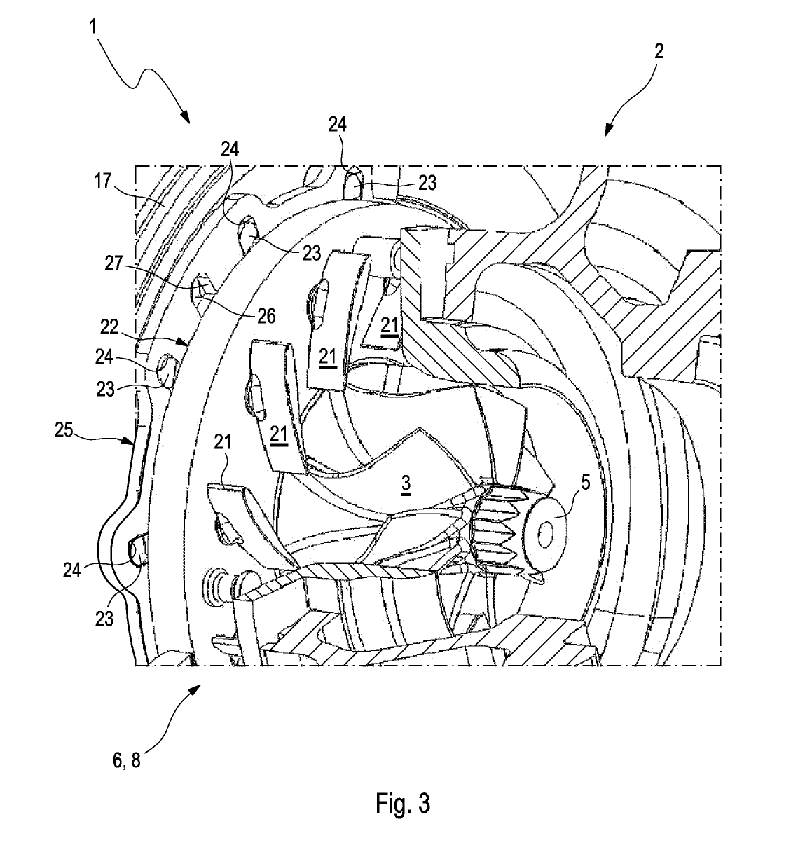

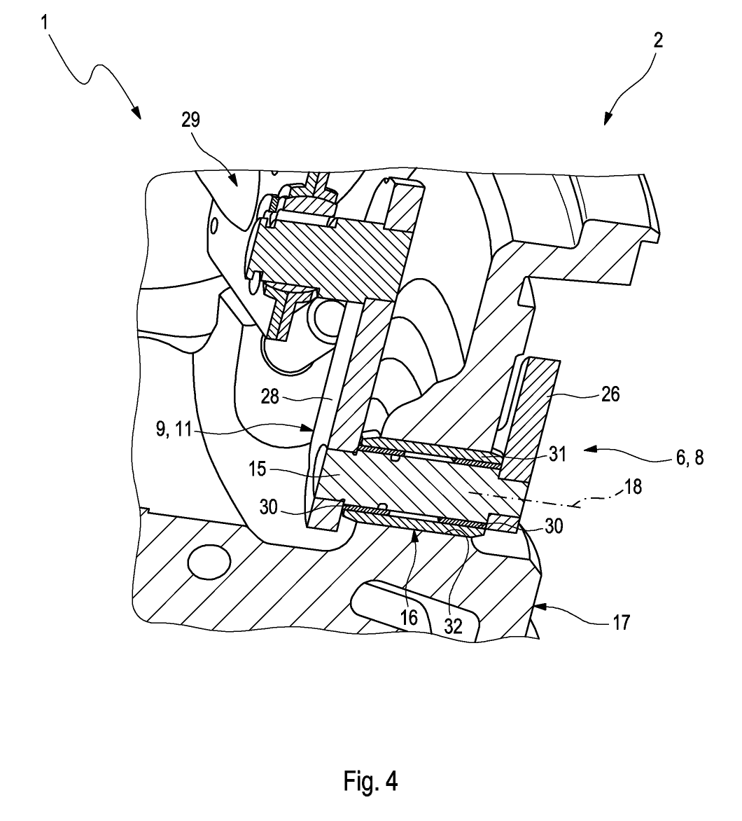

According to the FIGS. 1 to 4, an exhaust gas turbocharger 1 comprises a turbine 2 with a turbine wheel 3 and a compressor 4 with a compressor wheel which is not noticeable here. The turbine 2 is drive-connected to the compressor 4. In detail, the turbine wheel 3 and the compressor wheel are drive-connected to one another via a common drive shaft 5. The turbine 2 is equipped with a control device 6 for the performance control of the turbine 2. The embodiment shown in the FIGS. 1 and 2 in the control device 6 is a waste gate 7. In contrast with this, the control device 6 in the embodiment shown in the FIGS. 3 and 4 is a geometry adjusting device 8, with the help of which a variable turbine geometry can be realised. The respective control device 6 in all cases comprises an actuator 9, which in the waste gate 7 is formed by a spindle 10 and which in the geometry adjusting device 8 is formed by a drive lever 11.

According to the FIGS. 1 and 2, the waste gate 7 comprises a bypass opening 12, which connects the high-pressure side of the turbine 2 with the low-pressure side of the turbine 2 subject to bypassing the turbine wheel 3. The bypass opening 12 is controllable with the help of a valve member 13. The valve member 13, which is configured as a valve disc here, is fastened on the spindle 10 for this purpose, preferentially moveably. The spindle 10 comprises an actuating arm 14, on which the valve member 13 is fastened or moveably attached, and a bearing shaft 15, which is pivotably mounted about a pivot axis 18 in a bearing 16 on a turbine housing 17. The bearing shaft 15 penetrates the turbine housing 17, in which the turbine wheel 3 is rotatably arranged. The bypass opening 12 is also formed in the turbine housing 17. The bearing shaft 15 is drive-connected to the valve member 13 inside in the turbine housing 17. Outside, on the turbine housing 17, the bearing shaft 15 is drive-connected to a coupling lever 19, which in turn is drive-connected to an actuating drive 20 of the waste gate 7. The spindle 10, i.e. generally the actuator 9, penetrates the turbine housing 17 in the bearing 16.

According to the FIGS. 3 and 4, the geometry adjusting device 8 comprises multiple guide blades 21, which are each pivotably arranged on a blade carrier 22. To this end, the guide blades 21 each penetrate the guide blade carrier 22 with a pin that is not noticeable here. On a side of the guide blade carrier 22 facing away from the guide blades 21, an actuating arm 23 is arranged on the respective pin in a rotationally fixed manner, which is in engagement with a corresponding recess 24, which to this end is formed on an adjusting ring 25. By twisting the adjusting ring 25, all guide blades 21 can thus be synchronously adjusted. For driving the adjusting ring 25, the previously mentioned drive lever 11 is provided. The drive level 11 likewise has a bearing shaft 15, with which it is likewise pivotably mounted about a pivot axis 18 in a bearing 16 on the turbine housing 17. Here, too, the bearing shaft 15 penetrates the turbine housing 17. On the inside of the turbine housing 17, the drive lever 11 has a driver arm 26, which is connected to the bearing shaft 15 in a rotationally fixed manner. The driver arm 26 engages in a drive recess 27 of the adjusting ring 25. By pivoting the drive lever 11, the driver arm 26 is also pivoted, which because of this drives the adjusting ring in the circumferential direction. Outside on the turbine housing 17, the drive lever 11 has a coupling arm 28, which is connected to the bearing shaft 15 in a rotationally fixed manner and which is drive-connected to an adjusting drive 29 of the geometry actuating device 8.

In the following, the mounting of the actuator 9 on the turbine housing 17 is discussed in more detail, wherein the following explanations are applicable both generally to any control device 6 having such an actuator 9 as well as especially to the two exemplary embodiments exemplarily shown here, namely to the embodiment according to the FIGS. 1 and 2 with the waste gate 7 on the one hand and to the embodiment according to the FIGS. 3 and 4 with the geometry adjusting device 8 on the other hand.

As is evident from the FIGS. 2 and 4, the bearing shaft 15 of the actuator 9 comprises at least one bearing sleeve 30. The respective bearing sleeve 30 in this case is in contact with the bearing shaft 15 radially inside and with the bearing 16 radially outside. Shown here are embodiments, in which two separate bearing sleeves 30 are arranged on the bearing shaft 15, which are arranged on the bearing shaft 15 axially spaced from one another. The axial direction in this case is defined by the pivot axis 18 of the bearing shaft 15.

The dimensioning or arrangement of the respective bearing sleeve 30 is effected in such a manner that the bearing shaft 15 is radially in contact with the bearing 16 exclusively via the bearing sleeves 30.

In the case of the preferred embodiments shown here, the respective bearing 16 comprises a bearing bush 31. The respective bearing bush 31 is in contact with the turbine housing 17 radially outside. To this end, the bearing bush 31 is inserted into a bearing opening 32 of the turbine housing 17, in particular pressed in. Radially inside, the respective bearing bush 31 is in contact with the bearing sleeves 30. Practically, the bearing bush 31 is arranged on the turbine housing 17 in a rotationally fixed manner. For example, the bearing bush 31 is inserted into the bearing opening 32 with a press fit.

Furthermore, the respective bearing sleeve 30 is preferably arranged on the bearing shaft 15 in a rotationally fixed manner. To this end, the respective bearing sleeve 30 can be pressed and/or shrunk onto the bearing shaft 15. It is likewise possible to connect the respective bearing sleeve 30 to the bearing shaft 15 in a rotationally fixed manner by means of a welded connection or soldered connection or by means of a positively joined connection. In the mounting formed thus, friction then only occurs between the bearing sleeves 30 and the bearing bush 31, as a result of which it is particularly easily possible to configure these as a tribological system. Thus, the materials of the bearing bush 31 on the one hand and of the bearing sleeves 30 on the other hand can be optimally matched to one another with respect to friction and wear, as a result of which a high functional safety and great longevity for the mounting can be realised. Of special advantage here is the circumstance that for the bearing shaft 15 itself a comparatively simple, cost-effective material can be used as a result of which the respective actuator 9 can be realised comparatively cost-effectively.

For a particularly low-friction tribological system it can be provided to produce the respective bearing sleeve 30 and/or the respective bearing bush 31 from a nickel-based alloy. It is possible, furthermore, to provide the respective bearing sleeve 30 with a nitrided layer preferentially radially outside. In addition or alternatively, the bearing bush 31 can be provided with a nitrided layer preferentially radially inside. The respective nitrided layer can have a layer thickness in radial direction that is in a range from including 5 μm to including 350 μm.

The bearing sleeves 30 are dimensioned smaller than the bearing bush 31 in the radial direction. In particular, a radially measured wall thickness of the bearing sleeve 30 can be a maximum of 50% or a maximum of 25% of a wall thickness of the bearing bush 31.

The respective bearing sleeve 30 can be produced in any suitable manner. Advantageous, here, is producing the bearing sleeve 30 through forming For example, a sheet metal strip can be annularly formed in order to form such a bearing sleeve 30. Preferred, however, is a forming, during which an annular body that is closed in the circumferential direction is created. Conceivable is for example deep-drawing or impact extruding the bearing sleeve 30 from a suitable flat blank.

1. A turbine for a supercharging device of an internal combustion engine, comprising:
a control device for performance control of the turbine,
wherein the control device includes at least one actuator, which is pivotably mounted about a pivot axis relative to a turbine housing,
the actuator having a bearing shaft, which is mounted in a bearing of the turbine housing,
wherein the bearing shaft includes at least one bearing sleeve, which is radially in contact with the bearing.

2. The turbine according to claim 1, wherein the bearing shaft is radially in contact with the bearing via the at least one bearing sleeve.

3. The turbine according to claim 1, wherein at least two bearing sleeves are provided, which are arranged on the bearing shaft axially spaced from one another.

4. The turbine according to claim 1, wherein the bearing sleeve is composed of a material other than the bearing shaft.

5. The turbine according to claim 1, wherein the bearing includes a bearing bush having a radial inside and a radial outside, the bearing bush radially in contact with the turbine housing via the radial outside and in contact with the bearing sleeve via the radial inside.

6. The turbine according to claim 4, wherein the bearing bush is arranged on the turbine housing in a rotationally fixed manner.

7. The turbine according to claim 1, wherein the bearing forms a bearing opening, and wherein the bearing sleeve is in contact with the turbine housing.

8. The turbine according to claim 1, wherein the bearing sleeve is arranged on the bearing shaft in a rotationally fixed manner.

9. The turbine according to claim 1, wherein the control device is a geometry adjusting device forming a variable turbine geometry, wherein the actuator is a drive lever for driving an adjusting ring for adjusting guide blades mounted on a blade carrier.

10. The turbine according to claim 1, wherein the control device is a waste gate, wherein the actuator is a spindle for driving a valve member of the waste gate.

11. The turbine according to claim 1, wherein the bearing sleeve is produced from a nickel-based alloy.

12. The turbine according to claim 1, wherein the bearing sleeve is nitrided.

13. The turbine according to claim 1, wherein the bearing sleeve is produced through forming.

14. An exhaust gas turbocharger for an internal combustion engine, comprising: a compressor and a turbine for driving the compressor
a turbine housing;
a control device for performance control of the turbine, the control device including at least one actuator pivotably mounted about a pivot axis relative to the turbine housing;
wherein the actuator includes a bearing shaft mounted in a bearing of the turbine housing, the bearing shaft having at least one bearing sleeve radially contacting the bearing, and wherein the bearing shaft radially contacts the bearing via the at least one bearing sleeve.

15. The turbocharger according to claim 14, further comprising another bearing sleeve radially contacting the bearing, wherein the bearing sleeves are axially spaced on the bearing shaft from one another.

16. The turbocharger according to claim 14, wherein the bearing includes a bearing bush having a radial inside and a radial outside, wherein the bearing bush is radially contacting the turbine housing via the radial outside and radially contacting the bearing sleeve via the radial inside.

17. The turbocharger according to claim 14, wherein the bearing forms a bearing opening and the bearing sleeve is in contact with the turbine housing.

18. The turbocharger according to claim 14, wherein the control device is a geometry adjusting device forming a variable turbine geometry, wherein the actuator is a drive lever for driving an adjusting ring for adjusting guide blades mounted on a blade carrier.

19. The turbocharger according to claim 14, wherein the control device is a waste gate, wherein the actuator is a spindle for driving a valve member of the waste gate.

20. An exhaust gas turbocharger for an internal combustion engine, comprising:
a compressor and a turbine for driving the compressor, the turbine including a turbine housing; and
a control device for performance control of the turbine, the control device including at least one actuator pivotably mounted about a pivot axis relative to the turbine housing;
wherein the actuator includes a bearing shaft mounted in a bearing of the turbine housing, wherein the bearing shaft includes at least two bearing sleeves radially contacting the bearing, the bearing sleeves arranged rotationally fixed on the bearing shaft axially spaced from one another, and wherein the bearing shaft radially contacts the bearing via the at least two bearing sleeves.
